(19) United States
(12) Patent Application Publication
(10) Pub. No.: US 2007/0204282 A1
(43) Pub. Date: Aug. 30, 2007

(54) Optical Scanning Apparatus For Various Appliances For Recording Or Reproducing Data Or Information Using An Optical Recording Medium

(75) Inventor: Martin Storz, Villingen-Schwenningen (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING, BOULOGNE-BILLIANCOURT (FR)

(21) Appl. No.: 11/579,040

(22) PCT Filed: Apr. 12, 2005
(86) PCT No.: PCT/EP05/03830

§ 371 Date: Oct. 30, 2006

(30) Foreign Application Priority Data
Apr. 28, 2004 (DE) 102004020952.9

(51) Int. Cl. G11B 7/00

(52) U.S. Cl. 720/664

(57) ABSTRACT

An optical scanning apparatus for various appliances for recording or reproducing data or information using an optical recording medium has an interchangeable driving segment for matching the optical scanning apparatus to various driving systems in various appliances for recording or reproducing data or information. The driving segment, which is a one-piece toothed rack, for example, has an asymmetrical screw head depression in a hole for receiving a countersunk-head screw which connects the driving segment to the optical scanning apparatus at a contact face provided as a reference face for the purpose of arranging the driving segment parallel to a guide bar on the optical scanning apparatus. The contact face is arranged so as to deviate from a vertical line relative to the axis of the countersunk-head screw, and a force which emanates from the asymmetrical screw C head depression and which is generated when the countersunk-head screw is screwed in ensures that the driving segment is arranged parallel to the guide bar on the optical scanning apparatus.

The invention relates to an optical scanning apparatus for various appliances for recording data or information on or for reproducing data or information from a disc-like optical recording medium, which scanning apparatus has an interchangeable driving segment for matching to the various driving systems in various appliances for recording or reproducing data or information.

Examples of appliances for recording or reproducing data or information using an optical recording medium are CD or DVD players, which use the optical scanning apparatus, a “pickup”, to read data or information from an optical recording medium, a Compact Disc—CD for short—or a Digital Versatile Disc—DVD for short—or to write data or information to the recording medium. The optical scanning apparatus, which is normally constructed from a coarse drive mechanism and a fine drive mechanism, is positioned over one or more data or information tracks on the disc-like recording medium using servocontrol loops. The optical scanning apparatus, which carries a fine drive mechanism called an actuator, is moved parallel to the disc-like recording medium by means of the coarse drive mechanism in order to cross numerous tracks on the recording medium. The coarse drive mechanism comprises a toothed rack, which is mounted on the optical scanning apparatus, and a gearwheel or comprises a spindle pickup and a spindle which are driven by means of an electric motor. In order to ensure that the optical scanning apparatus is guided as precisely as possible, there is normally at least one guide bar which is mounted on the housing or on a board and is used to guide the optical scanning apparatus. The toothed rack or the spindle pickup need to be arranged as near to parallel to the guide bar as possible in order to ensure that the optical scanning apparatus is guided with low friction and nevertheless without play, without oscillating and quickly. The drive provided is a toothed rack, for example, which, to compensate for any play, is formed from two rows of teeth braced resiliently against one another and is mounted on the optical scanning apparatus using centring pins and screws. Centring pins need to be produced with a high level of dimensional accuracy, however, and may become damaged in the production process or during assembly. Alternatively, toothed racks are also used which can pivot resiliently around the guide bar and are connected to the optical scanning apparatus by means of drivers. In addition, spindle drive mechanism (already mentioned) are known, which means that for parallel orientation using centring pins there is insufficient space available to design an optical scanning device such that it can be matched to the various types of drive mechanism for various appliances for recording or reproducing data or information with a driving segment, subsequently referred to as interchangeable element.

It is therefore an object of the invention to mount the toothed rack or another interchangeable element on the optical scanning apparatus with little space requirement and without additional aids, such as centring pins or adjusting gauges, which results in parallel orientation of the interchangeable element relative to the guide bar on the optical scanning apparatus.

This object is achieved by means of features specified in independent claims. Advantageous refinements are specified in dependent claims.

Parallel orientation of the toothed rack or of another interchangeable element, such as a spindle pickup, relative to the guide bar on the optical scanning device is achieved without additional aids, such as centring pins or adjusting gauges, and with a low space requirement by virtue of the interchangeable element having an asymmetrical screw head depression, and there being a reference face onto which the interchangeable element is pressed with a force component which is formed by the asymmetrical screw head depression when the interchangeable element is mounted on the optical scanning apparatus using a countersunk-head screw. The asymmetrical screw head depression is an asymmetrically shaped screw head depression or a screw head depression which is arranged asymmetrically relative to the hole which is used to mount the interchangeable element on the optical scanning device. When the countersunk-head screw for connecting the interchangeable element to the optical scanning apparatus is screwed in, the asymmetrical screw head depression generates a force which acts at right angles to the longitudinal axis of the screw and is directed against the reference face of the optical scanning apparatus and which presses the interchangeable element onto the reference face, provided as a contact face, of the optical scanning apparatus for the purpose of parallel orientation relative to the guide bar. By way of example, the asymmetrical screw head depression, which is formed by an asymmetrically shaped screw head depression, is an incomplete conical or tapered depression which extends or flattens the hole only in part. In principle, however, it is also possible to use incomplete drill holes. In this case, the incomplete form refers to the shape of the depression, which, as a departure from a symmetrical and hence complete depression, has a region in which the radius or a distance corresponding to the radius from the centre point of the hole is shorter than is required to hold the countersunk head of the countersunk-head screw completely. Such a portion of the depression is arranged in the direction in which a countersunk-head screw is intended to be used to generate a force component which acts at right angles to its axis for the purpose of pressing the interchangeable element onto the reference face. The cross-section through the screw head depression is asymmetrical and, by way of example, is in the form of a circle truncated in one region. The cross-section through the screw head depressions is in that case a circle segment whose height is chosen to be greater than its radius and less than its diameter. When the countersunk-head screw is screwed in, the asymmetrical shape of the screw head depressions in the interchangeable element generates a force component which presses the interchangeable element against the contact face provided as a reference face. This connects an interchangeable element, which is a toothed rack, for example, to the optical scanning apparatus parallel to a guide bar. For parallel orientation relative to the guide bar, the toothed rack bears against one or against two contact faces of the optical scanning apparatus which are provided as reference faces.

In line with a further embodiment of the asymmetrical screw head depression, a screw head depression is provided which is arranged asymmetrically relative to a hole in the interchangeable element which is provided for the purpose of connecting the interchangeable element to the optical scanning apparatus using a countersunk-head screw. The screw head depression arranged eccentrically relative to the hole likewise has a portion in which the radius or a distance corresponding to the radius from the centre point of the hole is shorter than is required to hold the countersunk head of the countersunk-head screw completely, which means that when the countersunk-head screw is screwed in a force which acts at right angles to the longitudinal axis of the screw and which is directed against the reference face is likewise generated, said force pressing the interchangeable element against the reference face, provided as a contact face, of the optical scanning apparatus for the purpose of parallel orientation relative to the guide bar.

Since the interchangeable element is a toothed rack or a spindle pickup which is normally made of a plastic material, little complexity is required in order to produce an asymmetrical screw head depression. The parallel orientation of the interchangeable element relative to the guide bar of the optical scanning apparatus with little space requirement and without additional aids, such as centring pins or adjusting gauges, is distinguished by a high level of accuracy, simple assembly and little assembly complexity and also little manufacturing complexity and robustness towards damage during assembly.

The invention is explained in more detail below using an exemplary embodiment which is shown in the figures.

In the drawings:

FIG. 1 shows a perspective bottom view of a drive in a DVD player with an optical scanning apparatus and a toothed rack provided for the coarse drive mechanism,

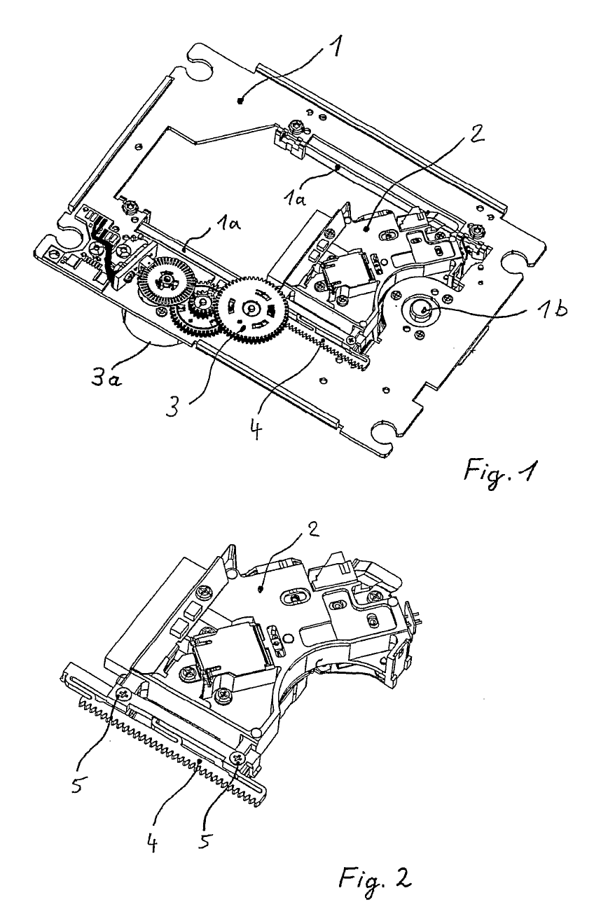

FIG. 2 shows a perspective bottom view of the optical scanning apparatus with the toothed rack provided as interchangeable element,

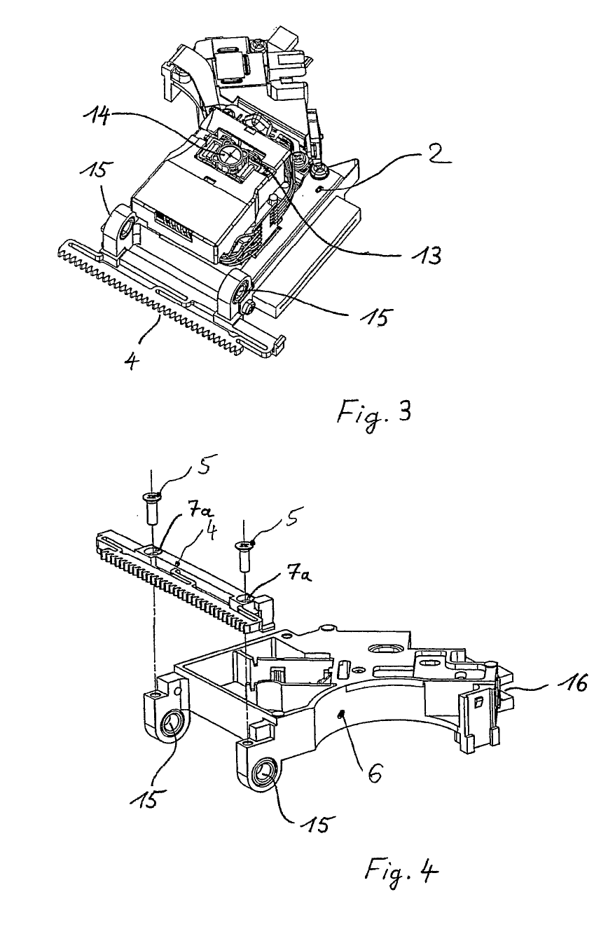

FIG. 3 shows a perspective top view of the optical scanning apparatus with the toothed rack,

FIG. 4 shows an exploded view of the toothed rack provided as interchangeable element on the optical scanning apparatus,

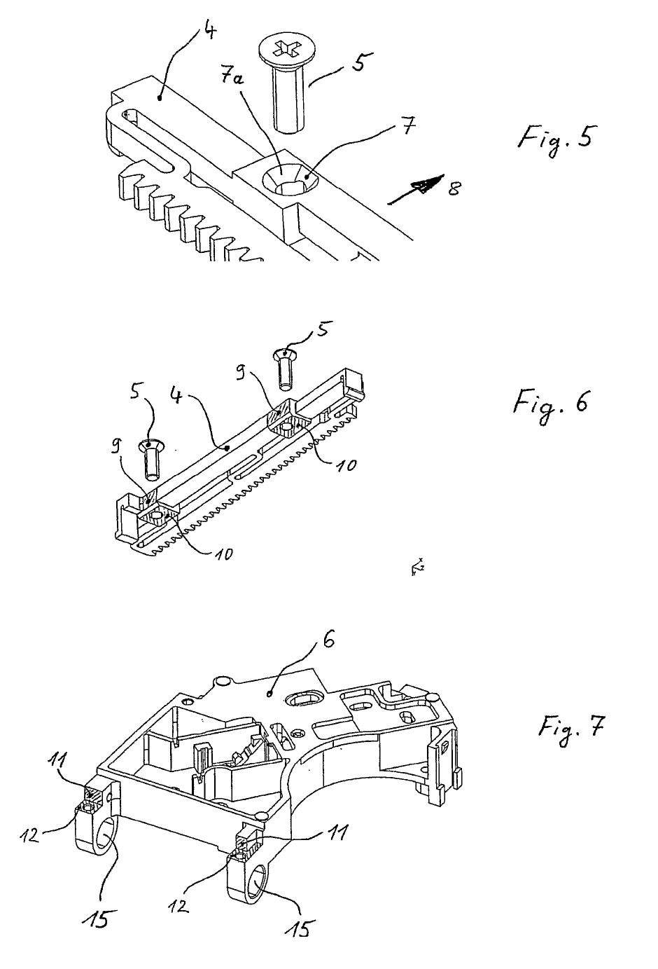

FIG. 5 shows a perspective view of a portion of the toothed rack with an asymmetrical screw head depression and a countersunk-head screw,

FIG. 6 shows a perspective illustration of a toothed rack with reference faces which is provided as interchangeable element,

FIG. 7 shows a perspective view of the basic body of the optical scanning apparatus for various types of drive mechanism, and

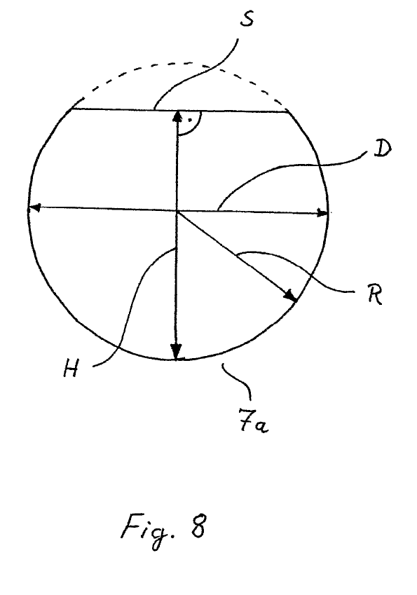

FIG. 8 shows a basic outline of the cross-section through an asymmetrical screw head depression.

Reference symbols are used to denote the same elements in the figures. FIG. 1 shows a perspective bottom view of the drive in an optical recording or reproduction appliance, e.g. a DVD player. A baseplate 1 in the appliance holds two guide bars la for guiding the optical scanning apparatus 2. A cylindrical gear 3, which is driven by means of an electric motor 3a, is in engagement with a toothed rack 4, which in this exemplary embodiment forms the interchangeable element which is arranged parallel to one of the guide bars 1a on the optical scanning apparatus 2. For the toothed rack 4, which represents a driving segment, the term interchangeable element is used in this case in order to illustrate that an optical scanning apparatus 2 is provided which can be used with various driving segments in various drives by connecting a driving segment which corresponds to the respective drive mechanism to the optical scanning apparatus 2. The driving segment shown in the exemplary embodiment is a one-piece toothed rack 4 which, for example to use the optical scanning apparatus 2 in a different drive, is interchanged with a two-piece toothed rack or a spindle pickup, which are normally permanently connected to the optical scanning apparatus 2. On the other hand, the space for those driving segments which are connected to the optical scanning apparatus 2 by means of drivers so as to be able to pivot resiliently around the guide bar 1a is required for a toothed rack. The driving segment therefore needs to be made interchangeable in order to be able to match the optical scanning apparatus 2 to the respective drive mechanism in different appliances. This advantageously makes it possible to use an optical scanning apparatus 2 which is designed as a standard assembly, and which inherently represents a complicated and complex assembly, in different appliances or drives. The interchange of the driving segment allows the use of the optical scanning apparatus 2 provided as a standard assembly in different appliances or drives in which, by way of example, a disc-like storage medium (not shown in FIG. 1) is driven by means of an electric motor 1b.

FIG. 2 shows the perspective view of the exemplary embodiment of an optical scanning apparatus 2 on which the toothed rack 4 is mounted using two countersunk-head screws 5, and FIG. 3 shows a perspective top view of the optical scanning apparatus 2. Arranged on the top of the optical scanning apparatus 2 is the “actuator” 13, which, with a focusing coil and a guide coil, forms the fine drive mechanism for a lens 14 in the optical scanning apparatus 2. On the side of the optical scanning apparatus 2 on which the toothed rack 4 provided as a driving segment is mounted, there are two guide holes 15 (shown in FIG. 3) which hold one of the guide bars la, in respect of which the driving segment provided as toothed rack 4 needs to be connected to the optical scanning apparatus 2 in a parallel orientation. To this end, without further aids, such as centring pins or adjusting gauges, there are two countersunk-head screws 5, as shown in the exploded view in FIG. 4. The toothed rack 4 provided as driving segment is mounted on the basic body 6 of the optical scanning apparatus 2 using the countersunk-head screws 5 and at the same time is oriented parallel to the guide bar 1a. Although a countersunk-head screw 5 guided through an appropriate hole with a screw head depression cannot be used to achieve sufficient accuracy for parallel orientation of the toothed rack 4 relative to the guide bar 1a without centring pins, particularly with a toothed rack 4 made of plastic, mounting the toothed rack 4 using the countersunk-head screws 5 achieves parallel orientation of the toothed rack 4 provided as interchangeable driving segment relative to the guide bar 1a by virtue of there being an asymmetrical screw head depression 7a and contact faces 9 to 12 (shown in FIGS. 6 and 7) as reference faces. In addition, FIG. 4 shows the aforementioned guide holes 15, which are arranged in spigots coming from the basic body 6 of the optical scanning apparatus 2. In the case of a toothed rack provided so that it can pivot around the guide bar 1a, the spigots form the aforementioned drivers, so that the toothed rack 4 shown in the exemplary embodiment cannot be used on account of the space required therefor. In order to be able to connect the toothed rack 4 to the optical scanning apparatus 2 selectively, the spigots contain threaded holes for the countersunk-head screws 5 which are used to mount the toothed rack 4 on the optical scanning apparatus 2. That side of the optical scanning apparatus 2 which is opposite the guide holes 15 has a guide groove 16 which is used to guide the basic body 6 of the optical scanning apparatus 2 along the second guide bar 1a.

FIG. 5 shows a portion of the toothed rack 4, which has an asymmetrically shaped screw head depression 7a in a hole which is provided for connecting the toothed rack 4 to the optical scanning apparatus 2 using a countersunk-head screw 5. The asymmetrical shape of the screw head depression 7a relates to a region 7 of the screw head depression 7a in which the depression is incomplete. To explain the function of an asymmetrical screw head depression 7a, FIG. 8 shows an outline of the cross-section through an asymmetrical screw head depression 7a. In the exemplary embodiment shown here, the screw head depression 7a is of asymmetrical shape or is an incomplete conical or tapered depression in a hole for a countersunk-head screw 5. By way of example, the cross-section through the screw head depression 7a is a circle segment whose height H is chosen to be greater than its radius R and less than its diameter D. The height H is greater than the thread diameter of the countersunk-head screw 5 and less than the diameter of the head of the countersunk-head screw 5. Whereas a full depression, as shown by a dashed line in FIG. 8, takes the countersunk head of a corresponding countersunk-head screw 5 completely, an incomplete countersunk head depression 7a generates, when the countersunk-head screw 5 is screwed in, not only a force component acting in the direction of the axis of the countersunk head screw 5 but also a force component which acts at right angles to the screw's axis, the latter force component being shown by an arrow 8 in FIG. 5. Two references faces which are provided at right angles to the force components, for example, and to which the interchangeable element is applied with the force components ensure parallel orientation of the interchangeable element or the toothed rack 4 relative to the guide bar 1a. The region 7 of the incomplete depression, which region is formed in FIG. 8, for example, by a chord S which limits the circular cross-section of a depression, is arranged in the direction in which a countersunk-head screw 5 is intended to generate a force component, acting at right angles to its axis, for pressing the interchangeable element onto the reference face. In the exemplary embodiment shown, the reference faces are formed by contact faces 9 and 10 of the toothed rack 4 (which are shown in FIG. 6) and by contact faces 11 and 12 of the basic body 6 of the optical scanning apparatus 2 (which are shown in FIG. 7), said contact faces being intended for orienting the toothed rack 4 parallel to the guide bar 1a in tune with one another. When the countersunk-head screw 5 is screwed in, the asymmetrical shape of the screw head depressions 7a in the interchangeable element generates force components which connect the toothed rack 4 to the optical scanning apparatus 2 at the contact faces 9 and 11 or 10 and 12 provided as reference faces.

In line with one exemplary embodiment (not shown), the asymmetrical screw head depression 7a is in the form of a screw head depression which is arranged asymmetrically relative to the hole used to mount the interchangeable element on the optical scanning apparatus 2. The screw head depression arranged eccentrically relative to the hole likewise has a region 7 in which the radius R or a distance corresponding to the radius R from the centre point of the hole is shorter than is required to hold the countersunk head of the countersunk-head screw 5 completely, which means that when the countersunk-head screw 5 is screwed in a force which acts at right angles to the longitudinal axis of the screw and is directed against the reference face is likewise generated.

The asymmetry of the cross-section through the screw head depression 7a relative to the hole means that when a countersunk-head screw 5 is screwed in a force component which acts at right angles to the countersunk-head screw 5 and is indicated by the arrow 8 is generated which presses the toothed rack 4 in the direction of the arrow 8 against a contact face 11 on the basic body 6 of the optical scanning apparatus 2.

FIG. 6 shows a perspective view of the back and the underside of the toothed rack 4, which have the contact faces 9 and 10 arranged on them. In the exemplary embodiment shown, the contact faces 9, 10 are provided parallel and at right angles to the hole for holding the countersunk-head screws 5. The edges of the contact faces 9 and 10, which abut one another at right angles, are flattened in order to avoid problems relating to tolerance and fit during assembly.

FIG. 7 shows a perspective view of the basic body 6 of the optical scanning apparatus 2. The basic body 6 has two contact faces 11 corresponding to the contact faces 9 of the toothed rack 4 and two contact faces 12 corresponding to the contact faces 10 of the toothed rack 4. When the countersunk-head screws 5 are screwed in, the contact faces 10 of the toothed rack 4 are pressed against the contact faces 12 of the basic body 6 by the axial screw force, while a force component generated as a result of the asymmetrical screw head depressions 7a presses the contact faces 9 of the toothed rack 4 against the contact faces 11 of the basic body 6. In this way, the toothed rack 4 will quickly and nevertheless very accurately attach to the basic body 6 of the optical scanning apparatus 2 parallel to the guide holes 15, which are provided for holding a guide bar 1a, in a simple work step—screwing—without any additional aids for centring. Since the interchangeable element is normally made from a plastic material, it is possible to produce an asymmetrical screw head depression 7a with little complexity. The parallel orientation of the interchangeable element relative to the guide bar 1a of the optical scanning apparatus 2 requires little space, is achieved without additional aids, such as centring pins or adjusting gauges, and is distinguished by a high level of accuracy, simple assembly and low assembly complexity and also low manufacturing complexity and robustness towards damage during assembly. The inventive solution is very space-saving, because no space-taking aids for centring the toothed rack 4 or the interchangeable element are required, which means that an optical scanning apparatus 2 designed as a standard assembly is matched to the various drive mechanisms from numerous manufacturers with little complexity.

The embodiments described here are indicated merely as examples, and a person skilled in the art may produce other embodiments of the invention which remain within the area of the invention. Examples of such embodiments are embodiments with reference faces which are arranged at an angle relative to one another which is different from 90° or, in contrast to the exemplary embodiment shown, have just one connecting face to the optical scanning apparatus 2.

1. Optical scanning apparatus for various appliances for recording or reproducing data or information using an optical recording medium, wherein a driving segment for matching the optical scanning apparatus to various driving systems in various appliances for recording or reproducing data or information has an asymmetrical screw head depression in a hole for receiving a countersunk-head screw which connects the driving segment of the optical scanning apparatus at a contact face provided as a reference face for the purpose of arranging the driving segment parallel to a guide bar on the optical scanning apparatus and which is arranged so as to deviate from a vertical line relative to the axis of the countersunk-head screw.

2. Optical scanning apparatus according to claim 1, wherein the asymmetrical screw head depression is a screw head depressions formed asymmetrically relative to the hole.

3. Optical scanning apparatus according to claim 1, wherein the asymmetrical screw head depression has the cross-section of a circle segment whose height is greater than the radius and is less than the diameter of the circle segment.

4. Optical scanning apparatus according to claim 1, wherein the asymmetrical screw head depression is a circular depression which is incomplete in one region and whose circular cross-section is reduced by a circle segment whose chordis arranged parallel to the contact face.

5. Optical scanning apparatus according to claim 1, wherein the asymmetrical screw head depression is a depression which is arranged asymmetrically relative to the hole and whose eccentricity relative to the hole is used, when screwing in the countersunk-head screw for connecting the driving segment to the optical scanning apparatuses, to orient the driving segment parallel to a guide bar.

6. Optical scanning apparatus according to claim 1, wherein the basic body 6of the optical scanning apparatuses bears, for the purpose of orienting an interchangeable driving segment parallel to a guide bar on the optical scanning apparatus in order to connect the driving segment to the optical scanning apparatus, contact faces which are provided as reference faces and are arranged so as to correspond to contact faces on the interchangeable driving segment.

7. Optical scanning apparatus according to claim 1, wherein the driving segment which is provided for matching the optical scanning apparatus to various driving systems and has an asymmetrical screw head depression in a hole for receiving a countersunk-head screw is used to orient the driving segment parallel to a guide bar on the optical scanning apparatuses.

8. Optical scanning apparatus according to claim 1, wherein the driving segment on the optical scanning apparatus is oriented parallel to a guide bar won the optical scanning apparatus by generating a force which acts at right angles to the longitudinal axis of the screw and is directed against a contact face, provided as a reference face, on the optical scanning apparatus when a countersunk-head screw is screwed in using a screw head depression for the countersunk-head screw which is arranged asymmetrically or whose cross-:section is in a form different from a circle.

9. Optical scanning apparatus according to claim 1, wherein the driving segment is an interchangeable driving segment which is formed with a one-piece toothed rack, with two toothed racks braced resiliently against one another or with a spindle pickup.

10. Optical scanning apparatus according to claim 1, wherein the driving segment is a toothed rack which is arranged in engagement with a gearwheel arranged on the baseplate of the appliance, the back of the toothed rack bears against at least one contact face on a basic body of the optical scanning apparatus the toothed rack and has an asymmetrical screw head depression for receiving a countersunk-head screw which is used to generate a force which acts at right angles to the longitudinal axis of the screw and is directed against the contact face when the countersunk-head screw is screwed in, said screw being provided for the purpose of orienting the toothed rack parallel to a guide bar which is arranged on the baseplate of the appliance.
